(19) United States
(12) Patent Application Publication
(10) Pub. No.: US 2011/0035416 A1
(43) Pub. Date: Feb. 10, 2011

(54) APPARATUS AND METHOD FOR EDITING DATA IN A PORTABLE TERMINAL

(75) Inventor: Hye-Kyung KIM, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/850,935

(22) Filed: Aug. 5, 2010

(30) Foreign Application Priority Data
Aug. 5, 2009 (KR) 10-2009-0071887

(51) Int. Cl. G06F 17/30

(52) U.S. Cl. 707/803; 707/E17.009

(57) ABSTRACT

An apparatus and method for editing data in a portable terminal are provided. The apparatus includes a data edit management unit for generating a layer corresponding to a region of original data intended for editing, and for applying an edit tag to the generated layer.

### PRIORITY

This application claims the benefit under 35 U.S.C. §119(a) of a Korean patent application entitled filed in the Korean Intellectual Property Office on Aug. 5, 2009 and assigned Serial No. 10-2009-0071887, the entire disclosure of which is hereby incorporated by reference.

### BACKGROUND OF THE INVENTION

1. Field of the Invention

The present invention relates to an apparatus and method for editing data in a portable terminal. More particularly, the present invention relates to an apparatus and method for performing an edit process without performing direct editing to text data in a portable terminal.

2. Description of the Related Art

Recently, portable terminals have become a necessity because of the convenience of portability. Thus, service providers (i.e., system manufacturers) have competitively developed portable terminals with more convenient functions to attract many users.

For example, the portable terminals provide functions such as, phone books, games, schedulers, Short Message Services (SMS), Multimedia Message Services (MMS), Broadcast Message Services (BMS), Internet services, Electronic mail (E-mail) messages, morning wakeup calls, Moving Picture Experts Group (MPEG)-1 Audio Layer 3 (MP3) players, digital cameras, and the like.

A user of a portable terminal can attempt to edit stored data according to individuality and generate the stored data as new data.

The attempt to edit is performed through an edit process in which a user applies a desired edit tag (i.e., effect) to multimedia data such as a previously stored image (e.g., User Created Contents (UCC)), text data, and the like.

However, the edit process, which is a process of directly applying a special effect such as a flower to the original stored image or directly applying an effect to the original data like underlining a specific region of the original text data, results in copyrighting data.

Therefore, a need exists for an edit apparatus and method for expressing a user's individuality by editing data in a portable terminal without copyrighting data.

### SUMMARY OF THE INVENTION

An aspect of the present invention is to address at least the above-mentioned problems and/or disadvantages and to provide at least the advantages below. Accordingly, an aspect of the present invention is to provide a tag edit apparatus and method for expressing a user's individuality in a portable terminal.

Another aspect of the present invention is to provide an apparatus and method for preventing editing of copyright data by avoiding direct editing of original data in a portable terminal.

A further aspect of the present invention is to provide an apparatus and method for enabling a search for contents of original data using a layer fulfilling tag editing in a portable terminal.

The above aspects may be achieved by providing an apparatus and method for editing data in a portable terminal.

In accordance with an aspect of the present invention, an apparatus for editing data in a portable terminal is provided. The apparatus includes a data edit management unit for generating a layer corresponding to a region of original data intended for editing, and for applying an edit tag to the generated layer.

In accordance with another aspect of the present invention, a method for editing data in a portable terminal is provided. The method includes designating a region of original data intended for editing and generating a layer corresponding to the region of the original data intended for editing, and selecting and applying an edit tag to the generated layer.

In accordance with still another aspect of the present invention, a method for editing data in a portable terminal is provided. The method includes generating a layer corresponding to a region of original data intended for editing, designating an edit region on the generated layer corresponding to the original data intended for editing, outputting an edit tag enabling data editing to the designated edit region on the generated layer, and applying the edit tag to the designated edit region.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating construction of a portable terminal performing a data edit process according to an exemplary embodiment of the present invention;

FIG. 2 is a flow diagram illustrating a data edit process of a portable terminal according to an exemplary embodiment of the present invention;

FIG. 3 is a flow diagram illustrating a layer search process of a portable terminal according to an exemplary embodiment of the present invention;

FIG. 4A illustrates a screen outputting data intended for editing in a portable terminal according to an exemplary embodiment of the present invention;

FIG. 4B illustrates a screen designating an edit region of data intended for editing in a portable terminal according to an exemplary embodiment of the present invention;

FIG. 4C illustrates a screen outputting a layer applying an edit tag thereto in a portable terminal according to an exemplary embodiment of the present invention; and

FIG. 4D illustrates a screen fulfilling data editing in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for expressing a user's individuality without directly editing original data in a portable terminal.

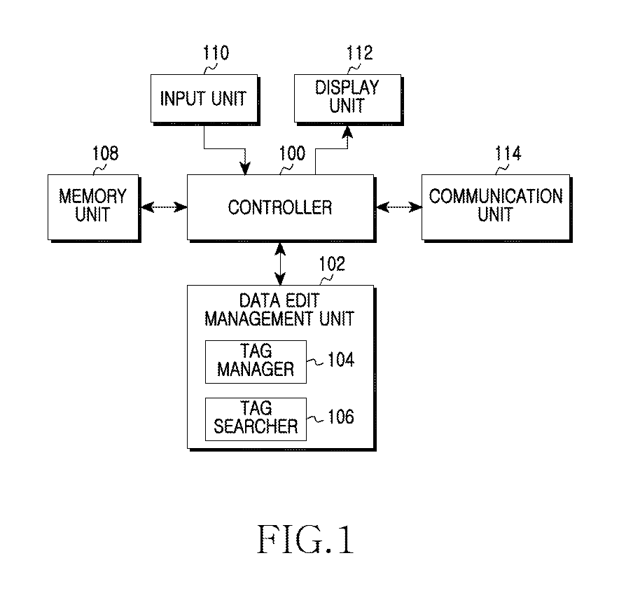

FIG. 1 is a block diagram illustrating construction of a portable terminal performing a data edit process according to an exemplary embodiment of the present invention.

Referring to FIG. 1, the portable terminal may include a controller 100, a data edit management unit 102, a memory unit 108, an input unit 110, a display unit 112, and a communication unit 114. The data edit management unit 102 may include a tag manager 104 and a tag searcher 106. The portable terminal may also include additional units. Similarly, the functionality of two or more of the above units may be integrated into a single component.

The controller 100 of the portable terminal controls general operations of the portable terminal. For example, the controller 100 performs processing and control for voice telephony and data communication. In addition to the general operations, if the controller 100 determines that a region of original data intended for editing is designated by a user, the controller 100 processes to generate a layer the same size as that of the original data. Also, an edit tag, which is selected by the user, may be applied to a position of the generated layer corresponding to the designated region of the original data intended for editing, thus providing the same effect as if the user directly applied the edit tag to the original data. As a result, editing of copyright data, which results from a process of directly editing the original data, i.e., directly applying an edit tag to the original data, is prevented.

After storing the layer with the edit tag applied thereto, the controller 100 processes to, by using the layer as a search filter, enable a search for the edit tag applied to a corresponding layer and the original data applying the edit tag thereto. That is, a user of the portable terminal may search the edit tag applied to a corresponding layer and access a position of the original data applying the edit tag thereto.

The data edit management unit 102 processes to provide the same effect as if a user edited the original data even without directly editing the original data, under control of the controller 100.

At this time, if it is determined that a region of the original data intended for edit is designated by a user, the data edit management unit 102 processes the tag manager 104 to generate a layer of the same size as that of the original data and apply an edit tag, which is selected by the user, to a position of the generated layer corresponding to the designated region of the original data intended for edit.

Also, the data edit management unit 102 processes the tag searcher 106 to search information on an edit tag applied to a corresponding layer and the original data applying the edit tag thereto.

The tag manager 104 generates a layer to apply an edit tag thereto and applies an edit tag selected by a user to the generated layer. The tag searcher 106 provides a position of the original data to which an edit tag is applied through a previously stored layer, to a user.

The memory unit 108 includes, for example, a Read Only Memory (ROM), a Random Access Memory (RAM), a flash ROM, and the like. The ROM stores a microcode (i.e., code) of a program for processing and controlling the controller 100 and the data edit management unit 102, and a variety of reference data.

The RAM, a working memory of the controller 100, stores temporary data generated in execution of a variety of programs. The flash ROM stores a diversity of updateable depository data such as a phone book, an outgoing message, an incoming message, and information on a user's touch input point. The flash ROM stores a layer to which an edit tag selected by a user is applied according to an exemplary embodiment of the present invention.

The input unit 110 includes numeral key buttons ‘0 ’ to ‘9 ’, a menu button, a cancel button, an OK button, a talk button, an end button, an Internet button, navigation key (or direction key) buttons, a plurality of function keys such as a character input key, and the like. The input unit 110 provides key input data corresponding to a key pressed by a user to the controller 100. These keys are merely examples of keys which may make up the input unit 110. The input unit may include additional or different keys, or different input mechanisms through which the user supplies input to the portable terminal.

The display unit 112 displays state information generated during operation of the portable terminal, limited number of characters, a large amount of moving pictures, still pictures, and the like. The display unit 112 may be a color Liquid Crystal Display (LCD), an Active Mode Organic Light Emitting Diode (AMOLED), and the like. The display unit 112 may include a touch input device. Thus, if a touch input scheme is applied to a portable terminal, the display unit 112 may be used as an input device.

The communication unit 114 performs a function of transmitting/receiving and processing a radio or other wireless signal through an antenna (not illustrated). For example, in a transmission mode, the communication unit 114 processes original data through channel coding and spreading, converts the original data into a Radio Frequency (RF) signal, and transmits the RF signal. In a reception mode, the communication unit 114 converts a received RF signal into a baseband signal, processes the baseband signal through de-spreading and channel decoding, and restores the signal to original data.

A function of the data edit management unit 102 may be implemented by the controller 100 of the portable terminal. However, each unit of the portable terminal is separately constructed and illustrated in the present invention as an exemplary construction for description convenience. It should be understood that various modifications of the construction may be made without limiting the scope of the present invention. For example, construction may also be such that each unit is processed in the controller 100.

An exemplary tag edit apparatus for expressing user's individuality even without performing direct edit for original data in a portable terminal has been described above. An exemplary tag edit method for expressing user's individuality and a method for searching contents of the original data using a layer fulfilling tag edit using the apparatus according to the exemplary embodiment of the present invention is described below.

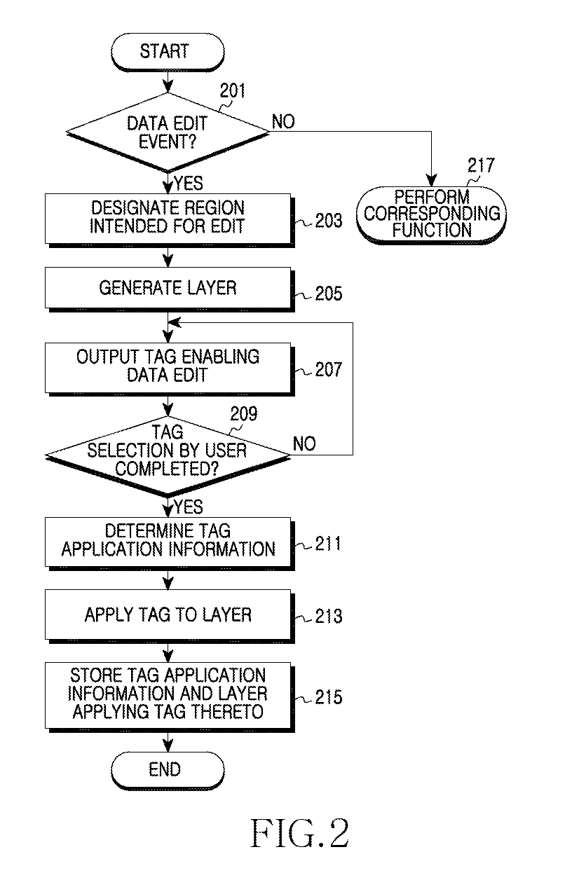

FIG. 2 is a flow diagram illustrating a data edit process of a portable terminal according to an exemplary embodiment of the present invention.

Referring to FIG. 2, the portable terminal determines if a data edit event occurs in step 201. The data edit event is an event for applying an edit tag such as an emphasis expression (e.g., a parenthesis, a quotation mark, an underline, a wave-shape mark, and the like) to data such as an image, a phonebook, a text, and the like. That is, the data edit event refers to not editing original image but generating the same layer as the original image and editing the layer.

If it is determined that the data edit event does not occur in step 201, the portable terminal performs a corresponding function (e.g., a standby mode) in step 217.

On the other hand, if the data edit event occurs in step 201, the portable terminal designates an edit region of the original data intended for editing in step 203. Thereafter, the portable terminal generates a layer for the original data in step 205. Here, the layer refers to an edit region capable of providing the same effect as if a user edited the original data without directly editing the original data. Thus, by simultaneously overlapping the layer and the original data, the user of the portable terminal may obtain the same effect as if the original data is directly edited, without directly editing copyright data.

Thereafter, the portable terminal outputs a tag enabling data editing in step 207 and then determines if the completion of a tag selection by a user is detected in step 209. Here, the tag enabling the data editing, which is a tag applicable to data intended for editing by a user, includes a quotation mark, an underline, a wave-shape mark, a parenthesis, and the like, for editing the original text data.

If it is determined that the tag selection by the user is not complete in step 209, the portable terminal detects a tag selection by a user in step 207.

On the contrary, if it is determined that the tag selection by the user is complete in step 209, the portable terminal determines tag application information in step 211. Here, the tag application information, which is information on a position in which a tag selected by the user is applied (i.e., information on the edit region intended for edit designated in step 203), may be information of a word included in the region applying the tag thereto, a page of the region applying the tag thereto, a paragraph, and the like. This is to allow the user of the portable terminal to search the tag and use the tag for searching information of the original data applying the tag thereto.

Thereafter, in step 213, the portable terminal applies the tag selected by the user to the generated layer of step 205. In step 215, the portable terminal stores the tag application information determined in step 211 and the layer applying the tag thereto in step 213.

The portable terminal then terminates the.

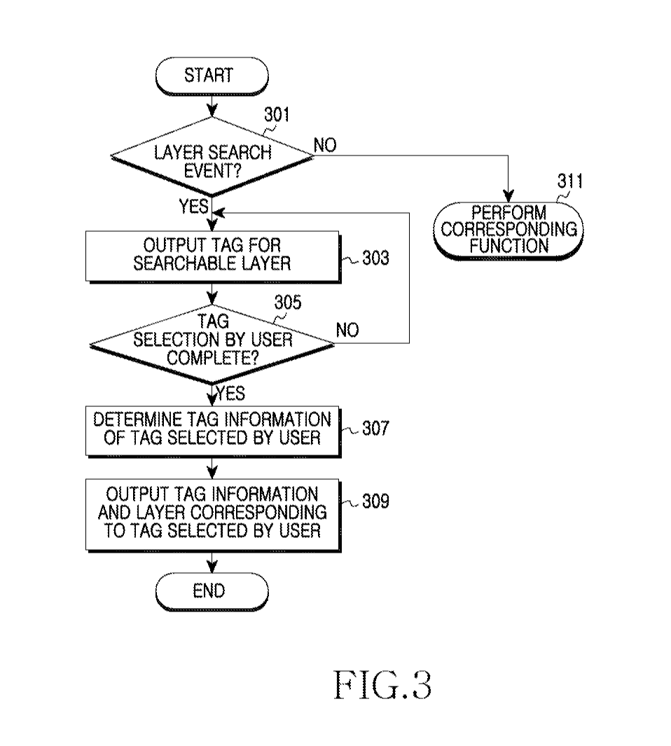

FIG. 3 is a flow diagram illustrating a layer search process of a portable terminal according to an exemplary embodiment of the present invention.

Referring to FIG. 3, in step 301, the portable terminal determines if a layer search event occurs. Here, the layer search event refers to an event for determining contents of original data applying an edit tag thereto, using a previously stored layer applying the edit tag thereto.

If it is determined that the layer search event does not occur in step 301, the portable terminal performs a corresponding function (e.g., a standby mode) in step 311.

On the other hand, if it is determined that the layer search event occurs in step 301, the portable terminal outputs an edit tag for a searchable layer in step 303. Here, the portable terminal outputs an edit tag corresponding to a previously stored layer, i.e., outputs a list of applied edit tags for every layer.

Thereafter, the portable terminal determines if a selection of an edit tag that a user intends to search is completed in step 305.

If it is determined that the selection of the edit tag by the user is complete in step 305, the portable terminal determines tag information of the edit tag selected by the user in step 307. Here, the tag information, which is information regarding a position in which the edit tag selected by the user is applied to the original data, may be information of a word included in a region of the original data applying the edit tag thereto, a page of the original data applying the edit tag thereto, a paragraph, and the like.

The portable terminal outputs the tag information and a layer corresponding to the edit tag selected by the user in step 309. For example, if the user of the portable terminal selects a tag “parenthesis” among a plurality of edit tags corresponding to a layer, the portable terminal processes to output information on a word, a page, and a paragraph of the original data to which the tag “parenthesis” is applied, to provide the information to the user.

Thereafter, the portable terminal terminates.

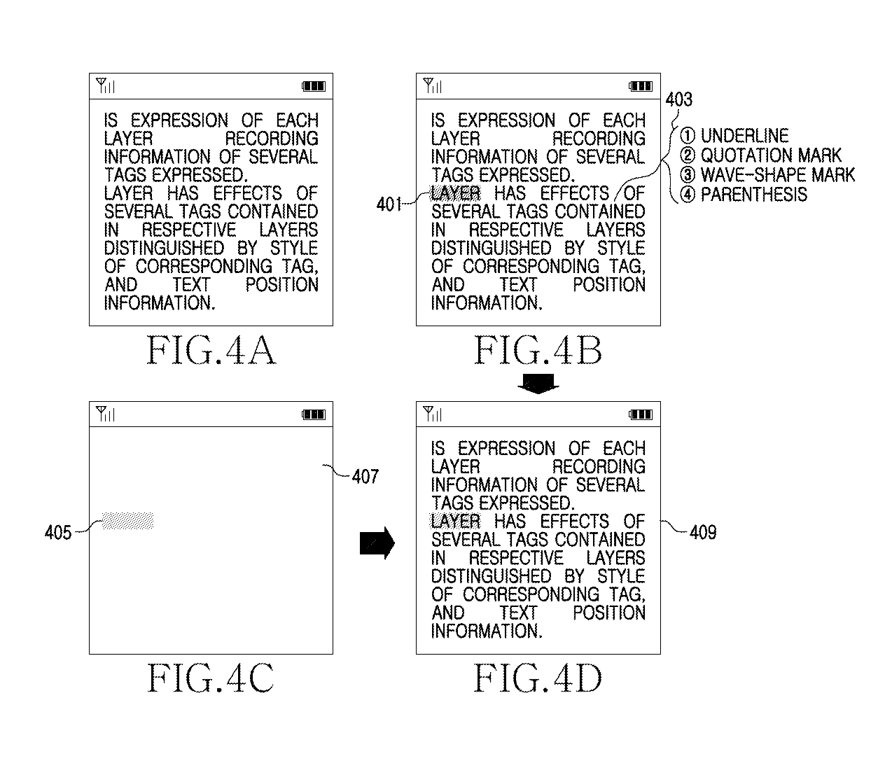

FIGS. 4A-4D are diagrams illustrating a data edit process of a portable terminal according to an exemplary embodiment of the present invention.

FIG. 4A illustrates a screen outputting data intended for editing in a portable terminal according to an exemplary embodiment of the present invention.

Referring to FIG. 4A, a user of the portable terminal outputs text data intended for editing. That is, as illustrated, the user may apply an edit tag such as an emphasis expression to the output text data. At this time, the portable terminal does not directly store the edit tag in the output original data but generates a separate layer applying the edit tag thereto, thus being able to prevent unauthorized editing of copyright data.

FIG. 4B illustrates a screen designating an edit region of data intended for editing in a portable terminal according to an exemplary embodiment of the present invention.

Referring to FIG. 4B, if a user of the portable terminal intends to edit the output text data of FIG. 4A, the user designates a region to which an edit tag may be applied. For example, as illustrated, if the user intends to apply an edit tag to a region 401 of “layer has”, the portable terminal outputs (403) a list of edit tags (e.g., an underline, a quotation mark, a wave-shape mark, a parenthesis, and the like) applicable to the region 401 of “layer has”.

FIG. 4C illustrates a screen outputting a layer applying an edit tag thereto in a portable terminal according to an exemplary embodiment of the present invention.

Referring to FIG. 4C, the portable terminal does not perform direct editing to original data output in the data edit process of FIG. 4B. However, as illustrated, the portable terminal applies an edit tag to a separate layer 407 corresponding to a position of an edit region of the original data. If a user selects an edit tag 405 “block mark”, the portable terminal applies the edit tag 405 “block mark” to the same layer region as a layer region of the original data.

FIG. 4D illustrates a screen fulfilling data editing in a portable terminal according to an exemplary embodiment of the present invention.

Referring to FIG. 4D, if a user of the portable terminal performs data editing, as aforementioned, an edit region of data intended for editing is designated and then an edit tag is applied to the edit region. At this time, the portable terminal applies the edit tag to a separate layer and combines the layer applying the edit tag thereto with the original data. Thus, an effect (409) as if the user directly processed the original data is provided by block marking.

That is, as illustrated in FIG. 4D, the portable terminal combines the original data of FIG. 4B with the layer applying the edit tag thereto of FIG. 4C, and provides the same effect as if the user directly applied the edit tag to the original data. As a result, the portable terminal may perform editing to the layer and does not perform editing to a combination of the original data and the layer applying the edit tag thereto.

The portable terminal may not only edit image data and text data, but also edit phonebook data of the portable terminal.

Regarding the phonebook data editing, after applying a specific edit tag to a user included in a phonebook, a user of the portable terminal may search only the user applying the edit tag thereto and determine corresponding information.

As described above, exemplary embodiments of the present invention provides an apparatus and method for enabling tag editing for expressing user's individuality without performing direct editing to original data in a portable terminal. By applying an edit tag to a separate layer corresponding to a region of the original data intended for editing, copyrighting of data which results from direct editing of original data is prevented.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for editing data in a portable terminal, the apparatus comprising:
a data edit management unit for generating a layer corresponding to a region of original data intended for editing, and for applying an edit tag to the generated layer.

2. The apparatus of claim 1, further comprising:
a tag manager for, after the applying of the edit tag to the generated layer, determining tag application information, which is information of the original data applying the edit tag thereto, and for storing the determined tag application information and the layer applying the edit tag thereto.

3. The apparatus of claim 1, further comprising:
a tag searcher for, when determining contents of the original data applying the edit tag thereto, outputting edit tags applied to a stored layer, and for determining tag application information of an edit tag selected to output information of the original data applying the selected edit tag thereto.

4. The apparatus of claim 1, wherein the generated layer comprises an edit region for providing the same effect as if the original data is directly edited.

5. The apparatus of claim 4, wherein the edit region of the generated layer provides the same effect as if the original data is directly edited, by combining the original data with the layer applying the edit tag thereto.

6. A method for editing data in a portable terminal, the method comprising:
designating a region of original data intended for editing, and generating a layer corresponding to the region of the original data intended for editing; and
selecting and applying an edit tag to the generated layer.

7. The method of claim 6, further comprising:
after applying the edit tag to the generated layer, determining tag application information, which is information of the original data applying the edit tag thereto; and
storing the determined tag application information and the layer applying the edit tag thereto.

8. The method of claim 6, further comprising:
when determining contents of the original data applying the edit tag thereto,
outputting edit tags applied to a stored layer; and
determining tag application information of an edit tag selected to output information of the original data applying the selected edit tag thereto.

9. The method of claim 6, wherein the generated layer comprises an edit region for providing the same effect as if the original data is directly edited.

10. The method of claim 9, wherein the edit region of the generated layer provides the same effect as if the original data is directly edited, by combining the original data with the layer applying the edit tag thereto.

11. A method for editing data in a portable terminal, the method comprising:
generating a layer corresponding to a region of original data intended for editing;
designating an edit region on the generated layer corresponding to the original data intended for editing;
outputting an edit tag enabling data editing to the designated edit region on the generated layer; and
applying the edit tag to the designated edit region.

12. The method of claim 11, wherein the edit tag includes an emphasis expression comprising at least one of a parenthesis, a quotation mark, an underline and a wave-shape mark.

13. The method of claim 11, further comprising:
determining edit tag application information of the designated edit region on the generated layer.

14. The method of claim 13, wherein the edit tag application information comprises information corresponding to the original data of at least one of a word, a page and a paragraph.

15. The method of claim 11, further comprising:
outputting an edit tag for a searchable layer to determine contents of the original data comprising edit tags.

16. The method of claim 15, further comprising:
selecting an edit tag to search and determining tag information of the selected edit tag.

17. The method of claim 16, wherein the tag information comprises position information of the selected edit tag.

18. The method of claim 17, further comprising:
outputting the tag information and a layer corresponding to the selected edit tag.
